(19) United States
(12) Patent Application Publication
(10) Pub. No.: US 2015/0066729 A1
(43) Pub. Date: Mar. 5, 2015

(54) SYSTEM AND METHOD FOR CURRENCY EXCHANGE RATE FORECASTING

(71) Applicant: MASTERCARD INTERNATIONAL INCORPORATED, Purchase, NY (US)

(72) Inventors: Po Hu, Norwalk, CT (US); Jean Pierre Gerard, Croton-on-Hudson, NY (US)

(73) Assignee: MASTERCARD INTERNATIONAL INCORPORATED, Purchase, NY (US)

(21) Appl. No.: 14/017,870

(22) Filed: Sep. 4, 2013

(51) Int. Cl. G06Q 40/04

(52) U.S. Cl. CPC G06Q 40/04
USPC 705/37

(57) ABSTRACT

A method for forecasting currency exchange rate is provided. The method involves: providing one or more databases configured to store a first set of information comprising microeconomic information that includes at least payment card holder transaction information; providing one or more databases configured to store a second set of information comprising macroeconomic information; and providing one or more databases configured to store a third set of information comprising foreign exchange market (Forex) information. The method also involves generating, from the first set of information, payment card holder transaction based variables in different currencies for comparable goods and/or services; integrating the payment card holder transaction based variables in different currencies, generated from the first set of information, with the second set of information and the third set of information; and forecasting the currency exchange rate based on the integrated information using a forecasting model that includes exogenous covariates, on a currency exchange time series. A system for forecasting currency exchange rate is also provided.

### BACKGROUND OF THE DISCLOSURE

1. Field of the Disclosure

The present disclosure relates to a system and method for forecasting currency exchange rate. In particular, the present disclosure relates to forecasting currency exchange rate based at least in part upon payment card holder financial transaction information (e.g., purchasing and payment transactions) in different currencies for comparable goods and/or services.

2. Description of the Related Art

Companies that do business internationally and/or companies that have foreign entities (e.g., subsidiaries) generally have business dealings in multiple currencies. Transactions in a foreign country may be conducted with a different currency than the currency used by the company for financial statements and reporting, for example. Due to the fluctuations in worldwide currency exchange rates, the use of different currencies could result in gains or losses for the company by merely having cash or accounts in different currencies.

Business entities that have gains or losses due to business transactions conducted in a foreign currency may be considered to have “currency exposure,” expressed as a currency pair and a value (e.g., the value of the transaction with the exchange rate applied). Note that the value of the transaction will likely change over time as the exchange rate between the two currencies changes. The risk of gain or loss due to exchange rate movement is referred to as “currency risk.” A currency risk can exist anywhere in the chain of business between a parent company, to a subsidiary, down to a vendor or customer. Currency risk exists for companies that conduct business (either directly or through a subsidiary) in a currency other than the currency associated with the company's financial reports or legal entities. Many companies are either unaware of the risk associated with currency exposure, or unaware of how to manage it. Even companies that are aware of the risk can encounter difficulty in identifying and managing the risk.

Not only does currency risk pose a challenge for companies that have operations in multiple currencies, forecasting further complicates currency risk management. To be fiscally sound, companies budget and forecast to establish financial expectations for continued operation. Forecasting is essentially an estimated guess at the future financial flows of the company, such as, for example, expected revenue, expected costs, and expected expenditures. While a company may correctly predict (at least within certain tolerances) the costs and transaction values for a transaction in a given currency, when those costs and transactions are subject to currency exchange rate movements the company's predictions may be incorrect due to currency risk.

Accordingly, there is a need for more accurate forecasting of currency exchange rates in an effort to minimize currency risk.

### SUMMARY OF THE DISCLOSURE

There is provided a system and method for forecasting currency exchange rate based at least in part upon payment card holder financial transaction information (e.g., purchasing and payment transactions) in different currencies for comparable goods and/or services.

There is also provided a method for forecasting currency exchange rate. The method involves: providing one or more databases configured to store a first set of information comprising microeconomic information that includes at least payment card holder transaction information; providing one or more databases configured to store a second set of information comprising macroeconomic information; and providing one or more databases configured to store a third set of information comprising foreign exchange market (Forex) information. The method also involves generating, from the first set of information, payment card holder transaction based variables in different currencies for comparable goods and/or services; integrating the payment card holder transaction based variables in different currencies, generated from the first set of information, with the second set of information and the third set of information; and forecasting the currency exchange rate based on the integrated information using a forecasting model that includes exogenous covariates, on a currency exchange time series.

There is further provided a system for forecasting currency exchange rate. The system includes: one or more databases configured to store a first set of information comprising microeconomic information that includes at least payment card holder transaction information; one or more databases configured to store a second set of information comprising macroeconomic information; and one or more databases configured to store a third set of information comprising foreign exchange market (Forex) information. The system also includes a processor configured to generate, from the first set of information, payment card holder transaction based variables in different currencies for comparable goods and/or services; integrate the payment card holder transaction based variables in different currencies, generated from the first set of information, with the second set of information and the third set of information; and forecast the currency exchange rate based on the integrated information using a forecasting model that includes exogenous covariates, on a currency exchange time series.

These and other systems, methods, objects, features, and advantages of the present disclosure will be apparent to those skilled in the art from the following detailed description of the preferred embodiment and the drawings.

### BRIEF DESCRIPTION OF THE DRAWINGS

FIG. 1 is a block diagram illustrating a high-level view of system architecture of a financial transaction processing system in accordance with exemplary embodiments.

FIG. 2 is a flow chart illustrating a method for forecasting currency exchange rate in accordance with exemplary embodiments of this disclosure.

FIG. 3 graphically depicts a payment transaction based model of a three day Dollar/Pound Sterling exchange rate in accordance with exemplary embodiments.

FIG. 4 is a flow chart illustrating a method for generating payment card holder transaction based variables in accordance with an embodiment of this disclosure.

FIG. 5 is a flow chart illustrating a method for forecasting currency exchange rate in accordance with an embodiment of this disclosure.

A component or a feature that is common to more than one figure is indicated with the same reference number in each figure.

### DETAILED DESCRIPTION OF THE DISCLOSURE

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these embodiments are provided so that this disclosure satisfies applicable legal requirements. Like numbers refer to like elements throughout.

As used herein, entities include one or more persons, organizations, businesses, institutions and/or other entities, such as financial institutions, services providers, and the like that implement one or more portions of one or more of the embodiments described and/or contemplated herein. In particular, entities include a person, business, school, club, fraternity or sorority, an organization having members in a particular trade or profession, sales representative for particular products, charity, not-for-profit organization, labor union, local government, government agency, or political party.

As used herein, “purchasing power parity” refers to an economic theory and a technique used to determine the relative value of currencies, estimating the amount of adjustment needed on the exchange rate between countries in order for the exchange to be equivalent to (or on par with) each currency's purchasing power. The technique determines how much money would be needed to purchase the same goods and services in two countries, and uses that to calculate an implicit foreign exchange rate. Using that purchasing power parity rate, an amount of money thus has the same purchasing power in different countries.

As used herein, “big data” refers to a collection of data sets so large and/or complex that it becomes difficult to process using on-hand database management tools or traditional data processing applications. The trend to larger data sets is due to the additional information derivable from analysis of a single large set of related data, as compared to separate smaller sets with the same total amount of data, allowing correlations to be found to spot business trends.

As used herein, the foreign exchange market (Forex) is a global decentralized market for the trading of currencies. The main participants in this market are the larger international banks. Financial centers around the world function as anchors of trading between a wide range of different types of buyers and sellers. The foreign exchange market determines the relative values of different currencies.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments of the present disclosure, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies, such as infrared, radio, and microwave, are included in the definition of medium. “Disk” and “disc” as used herein include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions that execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

Thus, apparatus, systems, methods and computer program products are herein disclosed to forecast currency exchange rates, and to identify, analyze, extract and correlate consumer activities that are used to generate the payment card holder transaction based variables in different currencies for comparable goods and/or services. Embodiments of the present disclosure will leverage the information available to identify data that is indicative of a customer's purchasing activities and, together with other microeconomic data, macroeconomic data and Forex quote data, to forecast currency exchange rates from that data.

In accordance with this disclosure, the ability of a company to manage currency risk can be greatly enhanced. A currency risk management system with forecast capability as described herein enables companies to focus time and energy on understanding and acting upon currency risk, rather than trying to gather and analyze other types of data that will indicate currency risk.

As used herein, “payment card holder” means a person or entity that possesses a payment card (e.g., credit card and/or debit card from a payment card company such as MasterCard®, VISA® or American Express®).

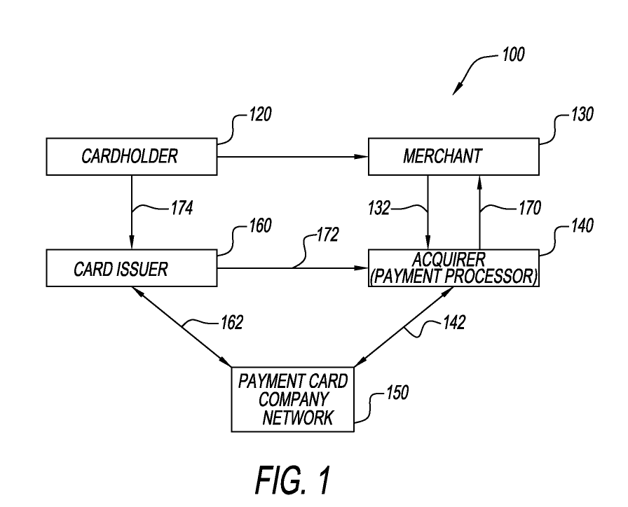

Referring to the drawings and, in particular, FIG. 1, there is shown a four party payment (credit, debit or other) card system generally represented by reference numeral 100. In card system 100, cardholder 120 submits the payment card to the merchant 130. The merchant's point of sale (POS) device communicates 132 with his acquiring bank or acquirer 140, which acts as a payment processor. The acquirer 140 initiates, at 142, the transaction on the payment card company network 150. The payment card company network 150 (that includes the financial transaction processing company) routes, via 162, the transaction to the issuing bank or card issuer 160, which is identified using information in the transaction message. The card issuer 160 approves or denies an authorization request, and then routes, via the payment card company network 150, an authorization response back to the acquirer 140. The acquirer 140 sends approval to the POS device of the merchant 130. Thereafter, seconds later, the cardholder completes the purchase and receives a receipt.

The account of the merchant 130 is credited, via 170, by the acquirer 140. The card issuer 160 pays, via 172, the acquirer 140. Eventually, the cardholder 120 pays, via 174, the card issuer 160.

In accordance with the present disclosure, an algorithm based on the theory of purchasing power parity tracks the level of overvaluation and undervaluation between a currency in one country and a currency in another country by comparing prices obtained in the local currency at point of sales (POS) for a wide range of goods and services as described herein. The transaction data provides a Big Data approach to forecasting accuracy. The number of data points allows time series analysis of purchase behavior in local currencies for many different baskets of goods and services and populations.

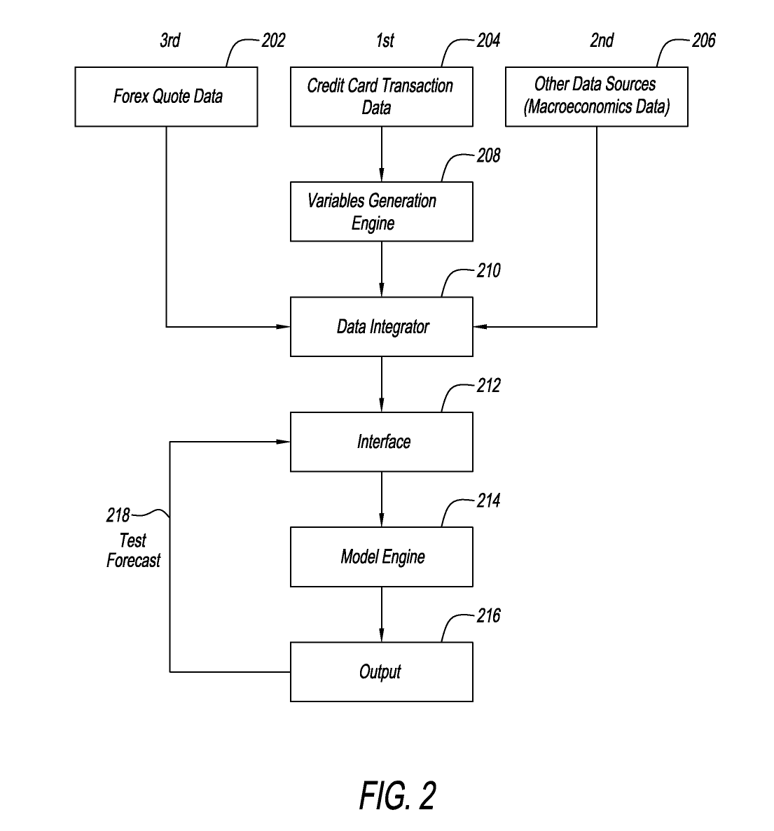

Referring to FIG. 2, in accordance with the method of this disclosure, one or more databases are configured at 204 to store a first set of information including microeconomic information. The microeconomic information includes at least payment card holder transaction information, e.g., payment card billing, purchasing and payment transactions, provided by a payment card company (part of the payment card company network 150 in FIG. 1). At 206, one or more databases are configured to store a second set of information including macroeconomic information. The macroeconomic information includes, for example, gross domestic product (GDP), interest rates, price indices, unemployment rates, and the like. At 202, one or more databases are configured to store a third set of information including foreign exchange market (Forex) information. The third set of information includes, for example, a source for streaming foreign exchange market (Forex) quotes.

At 208, payment card holder transaction based variables in different currencies for comparable goods and/or services are generated from the first set of information. The payment card holder transaction based variables include payment card purchasing and payment transactions in different currencies for comparable goods and/or services.

At 210, the payment card holder transaction based variables in different currencies, generated from the first set of information, are integrated with the second set of information and the third set of information. The integration of information uses one or more integrating algorithms.

In an embodiment, an interface 212 is used between the integrated information and the forecasting model described below. Parameters of the forecasting model are controlled at the interface 212.

At 214, the currency exchange rate is forecasted based on the integrated information using a forecasting model that includes exogenous covariates, on a currency exchange time series. Preferably, the forecasting model is an autoregressive integrated moving average (ARIMA) model that includes exogenous covariates. Forecasting the currency exchange rate using a forecasting model involves the use one or more forecasting algorithms.

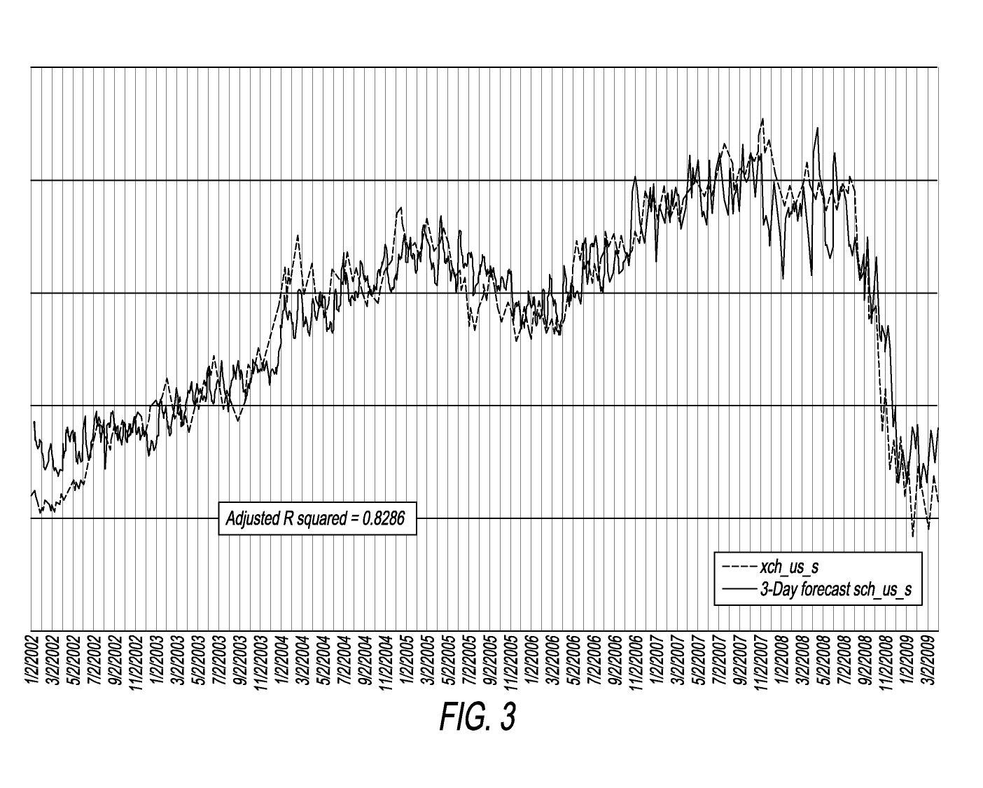

At 216, the forecasted currency exchange rate is used for short term forecasts, e.g., by traders, and long term forecast, e.g., by risk managers. FIG. 3 graphically depicts a payment transaction based model of a three day Dollar/Pound Sterling exchange rate in accordance with exemplary embodiment of this disclosure.

In an embodiment, at 218, the method of this disclosure also includes tracking and measuring the forecasted currency exchange rate compared to the actual currency exchange rate for a period of time, after the forecast has been made.

In accordance with the method of this disclosure, information that is stored in one or more databases can be retrieved (e.g., by a processor). The information can contain, for example, purchasing and payment activities attributable to payment card holders in one database, macroeconomic information (e.g., gross domestic product (GDP), interest rates, price indices and unemployment rates) in another database, and Forex quote data (e.g., foreign currency exchange market quotes) in yet another database. Illustrative information can include, for example, financial (e.g., billing statements and payments), purchasing information, geographic (e.g., country of financial transaction), and the like.

In an embodiment, all information stored in the one or more databases can be retrieved. In another embodiment, less than all information in the one or more databases can be retrieved. The retrieval of information can be performed a single time, or can be performed multiple times. For example, in the database containing macroeconomic information, only information concerning interest rates and unemployment rates can be retrieved in a first retrieval. In a second retrieval, information concerning gross domestic product (GDP) and price indices can be retrieved.

In accordance with the method of this disclosure, payment card holder transaction based variables in different currencies for comparable goods and/or services are generated based at least in part on the information from the financial transaction processing entity (e.g., payment card company). Payment card holder transaction based variables can be selected based on the information obtained and stored in the one or more databases containing microeconomic information. The selection of information for representation in the payment card holder transaction based variables can be different in every instance. In one embodiment, all information stored in the database can be used for selecting payment card holder transaction based variables. In an alternative embodiment, only a portion of the information can be used. The generation and selection of payment card holder transaction based variables can be based on specific criteria.

Payment card holder transaction based variables in different currencies for comparable goods and/or services are generated from the information obtained from the database containing microeconomic information. The information is analyzed, extracted and correlated by, for example, a financial transaction processing company (e.g., a payment card company), and can include financial account information, performing statistical analysis on financial account information, relating information on a financial account with other financial accounts, or any other method of review suitable for the particular application of the data, which will be apparent to persons having skill in the relevant art.

The payment card holder transaction based variables in different currencies for comparable goods and/or services are conveyed by the financial transaction processing entity to the data integrator configured to store payment card holder transaction based variables. This enables access to the one or more databases configured to integrate the payment card holder transaction based variables in different currencies, generated from the first set of information, with the second set of information and the third set of information. Forecasting of currency exchange rates can then be affected based on the integrated information, including the payment card holder transaction based variables.

Payment card holder transaction based variables can be defined based on geographical information, such as, for example, country of financial transaction. In some embodiments, payment card holder transaction based variables can include a plurality of geographical categories. For example, payment card holder transaction based variables can define a cardholder that purchases a good or service in one currency in, for example, London, England, Liverpool, England, Sheffield, England, and Nottingham, England, and another cardholder that purchases a comparable good or service in New York, N.Y., Chicago, Ill. and Los Angeles, Calif.

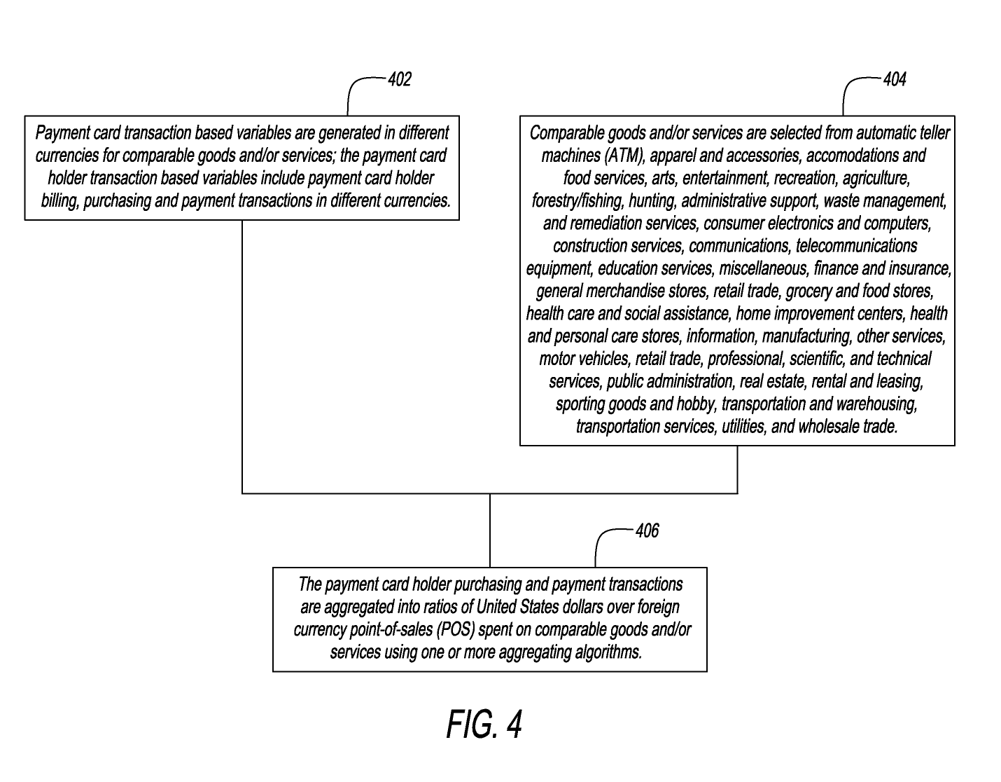

A method for generating payment card holder transaction based variables is a preferred embodiment of this disclosure. Referring to FIG. 4, the method involves a payment card company (part of the payment card company network 150 in FIG. 1) retrieving, from one or more databases, payment card holder transaction information in different currencies for comparable goods and/or services. The information 402 comprises payment card billing, purchasing and payment transactions in different currencies for comparable goods and/or services, and optionally geographic information.

The comparable goods and/or services 404 include, for example, automatic teller machines (ATM), apparel and accessories, accommodations and food services, arts, entertainment, recreation, agriculture, forestry/fishing, hunting, administrative support, waste management, and remediation services, consumer electronics and computers, construction services, communications, telecommunications equipment, education services, miscellaneous, finance and insurance, general merchandise stores, retail trade, grocery and food stores, health care and social assistance, home improvement centers, health and personal care stores, information, manufacturing, other services, motor vehicles, retail trade, professional, scientific, and technical services, public administration, real estate, rental and leasing, sporting goods and hobby, transportation and warehousing, transportation services, utilities, and wholesale trade.

At 406, the payment card holder transaction information in different currencies for comparable goods and/or services is aggregated into ratios of United States dollars over foreign currency point-of-sales (POS) spent on comparable goods and/or services using one or more aggregating algorithms. The aggregated payment card holder transaction information in different currencies for comparable goods and/or services information is then integrated with the second set of information (e.g., macroeconomic information) and the third set of information (e.g., foreign exchange market (Forex) information). Based on the integrated information, the currency exchange rate can then be forecasted using a forecasting model that includes exogenous covariates on a currency exchange time series.

In an embodiment, for the payment card holder transaction based variables in different currencies generated from the first set of information, input data and output variables are stored in two separate physical storages.

There is the potential for numerous information in payment card holder transaction based variables including, but not limited to, industries (consumer electronics, QSR), categories (online spend, cross border), geography spend (spend in New York City, spend in London), geography residence (live in New York City, live in Seattle), day/time spend (weekday spend, lunch time spend), and calendar spend (spend a lot around Christmas).

Payment card holders can represent a wide variety of categories and attributes with regard to purchasing goods and services. In one embodiment, payment card holders can be created based on spending in a particular industry. Industries can include, but is not limited to, as will be apparent to persons having skill in the relevant art, restaurants (e.g., fine dining, family restaurants, fast food), apparel (e.g., women's apparel, men's apparel, family apparel), entertainment (e.g., movies, professional sports, concerts, amusement parks), accommodations (e.g., luxury hotels, motels, casinos), retail (e.g., department stores, discount stores, hardware stores, sporting goods stores), automotive (e.g., new car sales, used car sales, automotive stores, repair shops), and travel (e.g., domestic, international, cruises). Each industry can include a plurality of payment card holders (e.g., based on location, income groups, and the like.).

Payment card transaction based variables can be updated or refreshed at a specified time (e.g., on a regular basis or upon request of a party). Updating payment card holder transaction based variables can include updating the entities included in each payment card holder transaction based variable with updated financial data. Payment card holder transaction based variables can also be updated by changing the attributes that define each payment card holder transaction based variable, and generating a different set of variables. The process for updating payment card transaction based variable information can depend on the circumstances regarding the need for the information itself.

One or more algorithms can be employed to determine formulaic descriptions of the assembly of the payment card holder information including payment card billing, purchasing and payment transactions and optionally geographic information, using any of a variety of known mathematical techniques. These formulas in turn can be used to derive or generate payment card holder transaction based variables using any of a variety of available trend analysis algorithms.

The aggregating, integrating, forecasting and processing algorithms all contribute to the collective forecast of currency exchange rate in accordance with the present disclosure. A wide range of algorithms can be used, and are desirably chosen according to the nature of the information that is being processed. Even with a particular forecasting environment, different algorithms can be applicable to different market conditions. This disclosure permits algorithms to be added and/or modified to improve forecast accuracy and speed under different or changing currency conditions.

Auxiliary components, such as procedures, algorithms, additional data, and/or other means for improving the algorithms via machine learning techniques, can improve the system's overall accuracy over time. Use of the Internet and state-of-art wireless capabilities can increase the quantity and quality of information used to generate currency exchange rate forecasts, thus increasing the accuracy of the system.

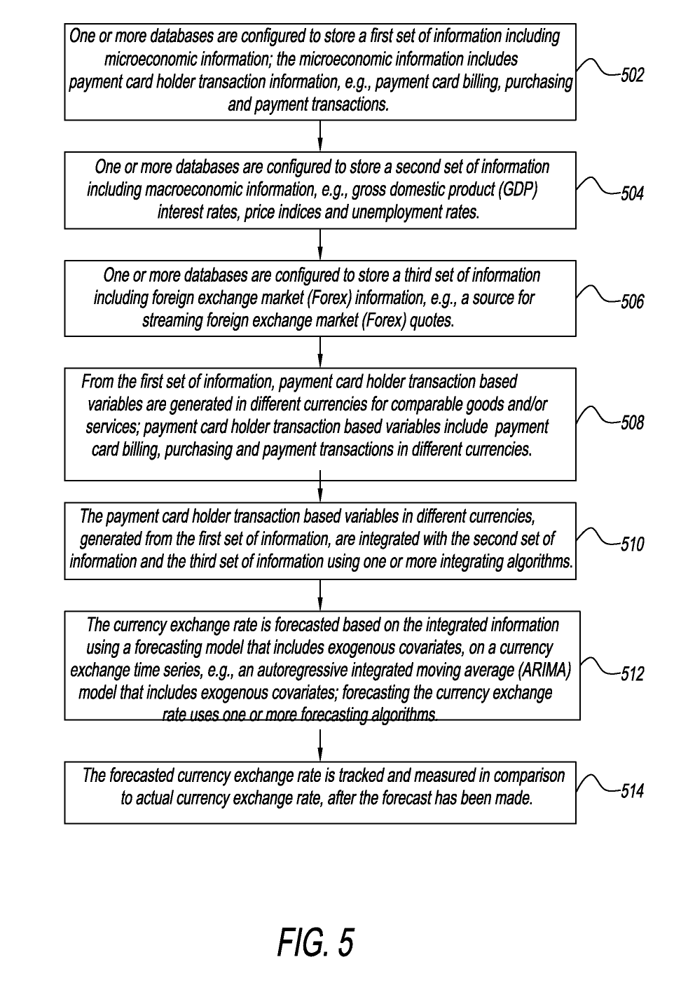

Referring to FIG. 5, in accordance with the method of this disclosure, one or more databases are configured at 502 to store a first set of information including microeconomic information. The microeconomic information includes at least payment card holder transaction information, e.g., payment card billing, purchasing and payment transactions, provided by a payment card company (part of the payment card company network 150 in FIG. 1). At 504, one or more databases are configured to store a second set of information including macroeconomic information. The macroeconomic information includes, for example, gross domestic product (GDP), interest rates, price indices, unemployment rates, and the like. At 506, one or more databases are configured to store a third set of information including foreign exchange market (Forex) information. The third set of information includes, for example, a source for streaming foreign exchange market (Forex) quotes.

At 508, payment card holder transaction based variables in different currencies for comparable goods and/or services are generated from the first set of information. The payment card holder transaction based variables include payment card purchasing and payment transactions in different currencies for comparable goods and/or services. The payment card holder transaction information in different currencies for comparable goods and/or services is aggregated into ratios of United States dollars over foreign currency point-of-sales (POS) spent on comparable goods and/or services using one or more aggregating algorithms.

The level of overvaluation and undervaluation between a currency in one country and a currency in another country is tracked by an algorithm, based on the theory of purchasing power parity, by comparing prices obtained in the local currency at point of sales (POS) for a wide range of goods and services as described herein. In accordance with this disclosure, the payment card holder purchasing and payment transaction data provides a Big Data approach to currency exchange rate forecasting accuracy. The number of data points of payment card holder purchasing and payment transactions allows time series analysis of purchase behavior in local currencies for many different baskets of goods and services and populations.

The comparable goods and/or services include, for example, automatic teller machines (ATM), apparel and accessories, accommodations and food services, arts, entertainment, recreation, agriculture, forestry/fishing, hunting, administrative support, waste management, and remediation services, consumer electronics and computers, construction services, communications, telecommunications equipment, education services, miscellaneous, finance and insurance, general merchandise stores, retail trade, grocery and food stores, health care and social assistance, home improvement centers, health and personal care stores, information, manufacturing, other services, motor vehicles, retail trade, professional, scientific, and technical services, public administration, real estate, rental and leasing, sporting goods and hobby, transportation and warehousing, transportation services, utilities, and wholesale trade.

At 510, the payment card holder transaction based variables in different currencies, generated from the first set of information are integrated with the second set of information and the third set of information. The integration of information uses one or more integrating algorithms.

In an embodiment, an interface is used between the integrated information and the forecasting model described below. Parameters of the forecasting model are controlled at the interface.

At 512, the currency exchange rate is forecasted based on the integrated information using a forecasting model that includes exogenous covariates, on a currency exchange time series. Preferably, the forecasting model is an autoregressive integrated moving average (ARIMA) model that includes exogenous covariates. Forecasting the currency exchange rate using a forecasting model involves the use one or more forecasting algorithms.

The model used is an ARIMAX(p,D,q) Model on the foreign exchange time series. The autoregressive moving average model including exogenous covariates, ARMAX(p,q), extends the ARMA(p,q) model by including the linear effect that one or more exogenous series has on the stationary response series yₜ. The general form of the ARMAX(p,q) model is

$${y}_{t} = {\sum }_{i = 1}^{p} {φ}_{i} {y}_{t - i} + {\sum }_{k = 1}^{r} {β}_{k} {x}_{tk} + {ɛ}_{t} + {\sum }_{j = 1}^{q} {θ}_{j} {ɛ}_{t - j} ,$$

and a condensed form in lag operator notation represented by the formula:

φ(L)yₜ=c+x′ₜβ+θ(L)εₜ.

In the condensed form in lag operator notation formula above, the vector x′ₜ holds the values of the r exogenous, time-varying predictors at time t, with coefficients denoted β.

The Interface controls parameters such as the forecast horizon, p,q, and exogenous factors (D).

The ARIMAX(p,D,q) Model can be used to check if a set of exogenous variables has an effect on a linear time series. For example, suppose a person wants to measure how the previous week's United Kingdom pound/sterling exchange rate, xₜ, affects this week's United States dollar exchange rate yₜ. The exchange rates are time series so an ARMAX model can be appropriate to study their relationships.

Conventions and extensions are associated with the ARIMAX(p,D,q) Model. ARMAX models have the same stationary requirements as ARMA models. Specifically, the response series is stable if the roots of the homogeneous characteristic equation of

φ(L)=^{p}−φ₁L^{p-1}−φ₂L^{p-2}− . . . φₚ

lie inside of the unit circle. See, for example, Wold, H., A Study in the Analysis of Stationary Time Series, Uppsala, Sweden: Almqvist & Wiksell, 1938.

If the response series yₜ is not stable, then it can be differenced to form a stationary ARIMA model. This can be done by specifying the degrees of integration D.

The ARIMA model software differences the response series yₜ before including the exogenous covariates if the degree of integration D is specified. In other words, the exogenous covariates enter a model with a stationary response. Therefore, the ARIMAX(p,D,q) model is

φ(L)yₜ=c*+x′ₜβ+θ*(L)εₜ,

where c^{*}=c/(1−L)^{D} and θ*(L)=θ(L)(1−L)^{D}. Subsequently, the interpretation of β has changed to the expected effect a unit increase in the predictor has on the difference between current and lagged values of the response (conditional on those lagged values).

The predictor series xₜ should be assessed whether they are stationary. Difference all predictor series that are not stationary with difference during the data preprocessing stage. If xₜ is nonstationary, then a test for the significance of β can produce a false negative. The practical interpretation of β changes if the predictor series is differenced.

The ARIMA model software uses maximum likelihood estimation for conditional mean models such as ARIMAX models.

Seasonal components can be included in an ARIMAX model which creates a SARIMAX(p,D,q)(pₛ,Dₛ,qₛ), model. Assuming that the response series yₜ is stationary, the model has the form

φ(L)Φ(L)yₜ=c+x′ₜβ+θ(L)Θ(L)εₜ,

where Φ(L) and Θ(L) are the seasonal lag polynomials. If yₜ is not stationary, then the degrees of nonseasonal or seasonal integration using ARIMA can be specified. If Seasonality≧0 is specified, then the software applies degree one seasonal differencing (Dₛ=1) to the response. Otherwise, Dₛ=0. The software includes the exogenous covariates after it differences the response.

The ARIMA model software treats the exogenous covariates as fixed during estimation and inference.

The ARIMAX(p,D,q) Model software is commercially available.

The forecasted currency exchange rate is used for short term forecasts and long term forecasts. The forecasted currency exchange rate is used for short term forecasts by traders and long term forecasts by risk managers.

In an embodiment, at 514, the method of this disclosure also includes tracking and measuring the forecasted currency exchange rate compared to the actual currency exchange rate for a period of time, after the forecast has been made.

It will be understood that the present disclosure can be embodied in a computer readable non-transitory storage medium storing instructions of a computer program that when executed by a computer system results in performance of steps of the system or method described herein. Such storage media can include any of those mentioned in the description above.

In particular, there is provided a computer readable non-transitory storage medium storing instructions of a computer program, which when executed by a computer system, results in performance of steps of: storing in an electronic storage device one or more databases configured to store payment card holder information including at least purchasing and payment activities attributable to the payment card holders, one or more databases configured to store macroeconomic information; and one or more databases configured to store foreign exchange market (Forex) information; generating, from the first set of information, payment card holder transaction based variables in different currencies for comparable goods and/or services; integrating the payment card holder transaction based variables in different currencies, generated from the first set of information, with the second set of information and the third set of information; and forecasting the currency exchange rate based on the integrated information using a forecasting model that includes exogenous covariates, on a currency exchange time series.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on”.

It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method for forecasting currency exchange rate, said method comprising:
providing one or more databases configured to store a first set of information comprising microeconomic information, wherein said microeconomic information comprises at least payment card holder transaction information;
providing one or more databases configured to store a second set of information comprising macroeconomic information;
providing one or more databases configured to store a third set of information comprising foreign exchange market (Forex) information;
generating, from the first set of information, payment card holder transaction based variables in different currencies for comparable goods and/or services;
integrating the payment card holder transaction based variables in different currencies, generated from the first set of information, with the second set of information and the third set of information; and
forecasting the currency exchange rate based on the integrated information using a forecasting model that includes exogenous covariates, on a currency exchange time series.

2. The method of claim 1, wherein the payment card holder transaction based variables comprise payment card holder purchasing and payment transactions in different currencies.

3. The method of claim 2, wherein the payment card holder purchasing and payment transactions are aggregated into ratios of United States dollars over foreign currency point-of-sales (POS) spent on comparable goods and/or services using one or more aggregating algorithms; wherein the comparable goods and/or services are selected from the group consisting of: automatic teller machines (ATM), apparel and accessories, accommodations and food services, arts, entertainment, recreation, agriculture, forestry/fishing, hunting, administrative support, waste management, and remediation services, consumer electronics and computers, construction services, communications, telecommunications equipment, education services, miscellaneous, finance and insurance, general merchandise stores, retail trade, grocery and food stores, health care and social assistance, home improvement centers, health and personal care stores, information, manufacturing, other services, motor vehicles, retail trade, professional, scientific, and technical services, public administration, real estate, rental and leasing, sporting goods and hobby, transportation and warehousing, transportation services, utilities, and wholesale trade.

4. The method of claim 1, wherein the payment card holder purchasing and payment transactions are aggregated into ratios of United States dollars over foreign currency point-of-sales (POS) spent on comparable goods and/or services using one or more aggregating algorithms.

5. The method of claim 1, wherein the payment card holder transaction based variables in different currencies are generated from the first set of information, and input data and output variables are stored in two separate physical storages.

6. The method of claim 1, wherein the first set of information comprises payment card holder billing, purchasing and payment transactions.

7. The method of claim 1, wherein the second set of information comprises gross domestic product (GDP), interest rates, price indices and unemployment rates.

8. The method of claim 1, wherein the third set of information comprises a source for streaming foreign exchange market (Forex) quotes.

9. The method of claim 1, wherein the payment card holder transaction based variables in different currencies, generated from the first set of information, are integrated with the second set of information and the third set of information using one or more integrating algorithms.

10. The method of claim 1, wherein the forecasting model comprises an autoregressive integrated moving average (ARIMA) model that includes exogenous covariates.

11. The method of claim 10, wherein the autoregressive integrated moving average (ARIMA) model has a general form represented by the formula:
$${y}_{t} = {\sum }_{i = 1}^{p} {φ}_{i} {y}_{t - i} + {\sum }_{k = 1}^{r} {β}_{k} {x}_{tk} + {ɛ}_{t} + {\sum }_{j = 1}^{q} {θ}_{j} {ɛ}_{t - j} ,$$
and a condensed form in lag operator notation represented by the formula:
φ(L)yₜ=c+x′ₜβ+θ(L)εₜ.

12. The method of claim 1, further comprising:
providing an interface between the integrated information and the forecasting model, wherein the forecasting model has parameters that are controlled at the interface.

13. The method of claim 1, wherein the forecasted currency exchange rate is used for short term forecasts and long term forecasts.

14. A system for forecasting currency exchange rate, said system comprising:
one or more databases configured to store a first set of information comprising microeconomic information, wherein said microeconomic information comprises at least payment card holder transaction information;
one or more databases configured to store a second set of information comprising macroeconomic information;
one or more databases configured to store a third set of information comprising foreign exchange market (Forex) information;
a processor configured to
generate, from the first set of information, payment card holder transaction based variables in different currencies for comparable goods and/or services;
integrate the payment card holder transaction based variables in different currencies, generated from the first set of information, with the second set of information and the third set of information; and
forecast the currency exchange rate based on the integrated information using a forecasting model that includes exogenous covariates, on a currency exchange time series.

15. The system of claim 14, wherein the payment card holder purchasing and payment transactions are aggregated into ratios of United States dollars over foreign currency point-of-sales (POS) spent on comparable goods and/or services using one or more aggregating algorithms.

16. The system of claim 14, wherein the payment card holder transaction based variables in different currencies is generated from the first set of information, and input data and output variables are stored in two separate physical storages.

17. The system of claim 14, wherein the first set of information comprises payment card holder billing, purchasing and payment transactions, the second set of information comprises gross domestic product (GDP), interest rates, price indices and unemployment rates, and the third set of information comprises a source for streaming foreign exchange market (Forex) quotes.

18. The system of claim 14, wherein the payment card holder transaction based variables in different currencies, generated from the first set of information, are integrated with the second set of information and the third set of information using one or more integrating algorithms.

19. The system of claim 14, wherein the forecasting model comprises an autoregressive integrated moving average (ARIMA) model that includes exogenous covariates.

20. The system of claim 19, wherein the autoregressive integrated moving average (ARIMA) model has a general form represented by the formula:
$${y}_{t} = {\sum }_{i = 1}^{p} {φ}_{i} {y}_{t - i} + {\sum }_{k = 1}^{r} {β}_{k} {x}_{tk} + {ɛ}_{t} + {\sum }_{j = 1}^{q} {θ}_{j} {ɛ}_{t - j} ,$$
and a condensed form in lag operator notation represented by the formula:
φ(L)yₜ=c+x′ₜβ+θ(L)εₜ.

21. The system of claim 14, further comprising an interface between the integrated information and the forecasting model, wherein parameters of the forecasting model are controlled at the interface.
